(19) United States
(12) Patent Application Publication
(10) Pub. No.: US 2021/0383803 A1
(43) Pub. Date: Dec. 9, 2021

(54) INFORMATION PROCESSING APPARATUS, CONTROL METHOD THEREOF, AND PROGRAM

(71) Applicant: SONY GROUP CORPORATION, TOKYO (JP)

(72) Inventor: YUUJI TAKIMOTO, TOKYO (JP)

(21) Appl. No.: 17/287,461

(22) PCT Filed: Sep. 30, 2019
(86) PCT No.: PCT/JP2019/038568

§ 371 Date: Apr. 21, 2021

(30) Foreign Application Priority Data
Nov. 1, 2018 (JP) 2018-206497

(51) Int. Cl. G10L 15/22; G10L 15/30; G06Q 30/06

(52) U.S. Cl. CPC G10L 15/22; G10L 15/30; G10L 2015/223; G06Q 30/0633; G06Q 30/0603

(57) ABSTRACT

To simplify a user's operation at the time of switching from a not-in-use state to an in-use state of a voice input system using a voice recognition technology. A solution is an information processing apparatus including a control unit that detects a plurality of users from sensor information from a sensor, selects at least one user depending on attributes of the plurality of users, controls so as to enhance a sound collection directivity of a voice of the user among voices input from a microphone, and controls so as to output notification information for the user.

### TECHNICAL FIELD

The present invention relates to an information processing apparatus, a control method thereof, and a program in a voice input system using a voice recognition technology.

### BACKGROUND ART

In recent years, home appliances including “voice agent” or “voice assistant” functions have been used. These are voice input systems using a voice recognition technology. In this technical field, a variety of technologies for improving a voice recognition accuracy have been developed (e.g., see Patent Literature 1).

### CITATION LIST

### Patent Literature

Patent Literature 1: Japanese Patent No. 6,221,535

### DISCLOSURE OF INVENTION

### Technical Problem

Some voice agents limit a part of their functions from a viewpoint of power saving or an improvement of a voice recognition accuracy until a voice input of a startup keyword is performed. In this case, in order to startup the voice agent, the user has to utter the startup keyword to the voice agent.

However, it is inconvenient for the user to have to utter the startup keyword each time. On the other hand, restricting a part of the functions of the voice agent when the user does not use the voice agent has merits such as power saving and prevention of malfunctions. Therefore, it needs a voice input system in which some of the functions can be restricted when not in use and which can be operated by the user without requiring the startup keyword when in use.

The present technology is made in view of the above-mentioned situation, and an object thereof is to simplify a user's operation at the time of switching from a not-in-use state to an in-use state of the voice input system using a voice recognition technology.

### Solution to Problem

An embodiment of the present technology for achieving the above object is an information processing apparatus including a control unit.

The control unit detects a plurality of users from sensor information from a sensor.

The control unit selects at least one user depending on attributes of the plurality of users.

The control unit controls so as to enhance a sound collection directivity of a voice of the user among voices input from a microphone.

The control unit controls so as to output notification information for the user.

In one embodiment of the present technology, the control unit detects a plurality of users, selects at least one user depending on the attributes of the plurality of users detected, controls the selected user to enhance the sound collection directivity of the voice, and outputs notification information for the selected user, so that when the information processing apparatus switches from a not-in-use state to an in-use state, the information processing apparatus can act on the selected user depending on the attributes. Thus, the sound collection directivity of the user's voice is enhanced without waiting for an utterance of the user's activation keyword, and the user's operation becomes simpler.

In the above-described embodiment, the control unit may confirm presence or absence of the notification information for at least one of the plurality of users, and, if at least one of the notification information is present, may control to output attention drawing information for drawing attention to the information processing apparatus, and may select the user from among users whose attention drawing information is detected to be directed to the information processing apparatus.

In the above-described embodiment, if there is at least one piece of notification information, the control unit outputs the attention drawing information and selects the user from among the users who have been detected to be directed to the information processing apparatus, so that the user's sound collection directivity in response to the attention drawing information is improved, and the user's operation becomes simpler.

In the above-described embodiment, the control unit may control to acquire a user name included in the notification information for at least one of the plurality of users, generate the attention drawing information including the acquired user name, and output the attention drawing information.

In the above-described embodiment, since the control unit is controlled to output the attention drawing information including the user name included in the notification information, it is possible to improve a response of the user who is called the name.

In the above-described embodiment, the notification information may be generated by any of a plurality of applications, and the control unit may select the user depending on the attributes and the types of the applications that generate the notification information.

In the above-described embodiment, the information processing apparatus can select a user who enhances the sound collection directivity depending on the attributes and the types of the applications.

In the above-described embodiment, the attributes include an age, the types of the plurality of applications include at least an application having a function of purchasing at least one of an article or a service, and the control unit may select the user from among users each having a predetermined age or more if the types of the applications generating the notification information corresponds to the application having the function of purchasing at least one of the article or the service.

In the above-described embodiment, when the application for purchasing the article or the like notifies the user of something, the user who enhances the sound collection directivity is limited to the user of a predetermined age or more, so that it is possible to provide an information processing apparatus that can be used by the user at ease.

In the above-described embodiment, the control unit may detect the plurality of users from the captured image by face recognition processing, and may select a user depending on the attributes of the user detected by the face recognition processing.

In the above-described embodiment, the attributes can be detected with high accuracy by using the face recognition processing.

In the above-described embodiment, the attributes includes the age, the control unit confirms presence or absence of the notification information to at least one of the plurality of users, and if the notification information is present and the notification information is intended for the user of a predetermined age or more, among the plurality of users detected from the captured image, the user may be selected from the user of the predetermined age or more.

In the above-described embodiment, in a case where the content of the notification information is intended for the user of the predetermined age or more, the user who enhances the sound collection directivity is limited to the user of the predetermined age or more, so that it is possible to provide an information processing apparatus that can be used by the user at ease.

In the above-described embodiment, the control unit may stop the control if an utterance from the user is not detected for a predetermined period of time after the control to enhance the sound collection directivity of the voice of the user is performed, and may set the length of the predetermined period of time depending on the attributes acquired for the user.

In the above-described embodiment, since the control unit sets the length of time until the control to enhance the sound collection directivity is stopped depending on the attributes if no utterance is detected, it becomes easier to operate the information processing apparatus for a user having attributes that are often unfamiliar with the operation of the information processing apparatus, such as an elderly person or a child.

In the above-described embodiment, if the notification information relating to the purchase of at least one of the article or the service is generated, the control unit may suspend the control to enhance the sound collection directivity depending on the attributes of the user.

In the above-described embodiment, if the notification information about the purchase of the article or the like is generated, the control to enhance the sound collection directivity depending on the attributes is suspended, so that it is possible to provide an information processing apparatus that can be used by the user at ease.

An embodiment of the present technology which achieves the above object is a control method of an information processing apparatus as follows:

A control method of an information processing apparatus, including:

detecting a plurality of users from a captured image of a camera,

selecting at least one user depending on attributes of the plurality of users,

controlling so as to enhance a sound collection directivity of a voice of the user among voices input from a microphone, and

controlling so as to output notification information for the user.

An embodiment of the present technology which achieves the above object is a program as follows:

A program executable by an information processing apparatus, the program causing the information processing apparatus to execute:

a step of detecting a plurality of users from sensor information;

a step of selecting at least one user depending on attributes of the plurality of users;

a step of controlling so as to enhance a sound collection directivity of a voice of the user among input voices; and

a step of controlling so as to output notification information for the user.

### Advantageous Effects of Invention

According to the present technology, it is possible to make the user's operation simpler.

However, this effect is one of the effects of the present technology.

### BRIEF DESCRIPTION OF DRAWINGS

FIG. 1 is a diagram showing an AI speaker according to an embodiment together with a situation of use thereof.

FIG. 2 is a block diagram showing a hardware configuration of the AI speaker according to the embodiment.

FIG. 3 is a block diagram showing content stored in a storage unit of the AI speaker according to the embodiment.

FIG. 4 is a diagram schematically showing a state in which a virtual beam for voice recognition is formed from the AI speaker according to the embodiment toward a user.

FIG. 5 is a flowchart showing a procedure of processing by a voice agent according to the embodiment.

FIG. 6 is a flowchart showing a method of selecting a user depending on attributes in the embodiment.

FIG. 7 is a flowchart showing a procedure of processing by a voice agent according to another embodiment.

FIG. 8 is a block diagram showing a procedure of processing by the voice agent according to another embodiment.

### MODE(S) FOR CARRYING OUT THE INVENTION

### First Embodiment

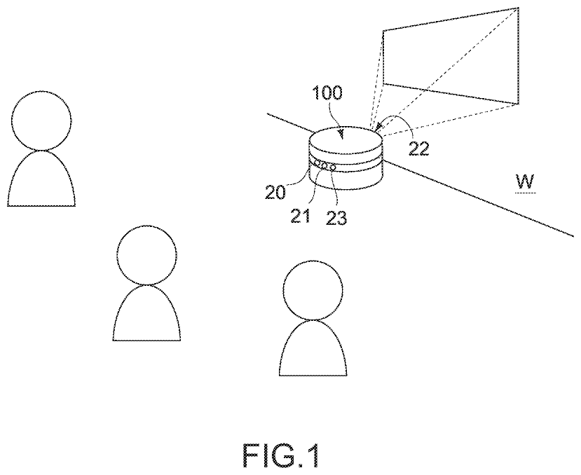

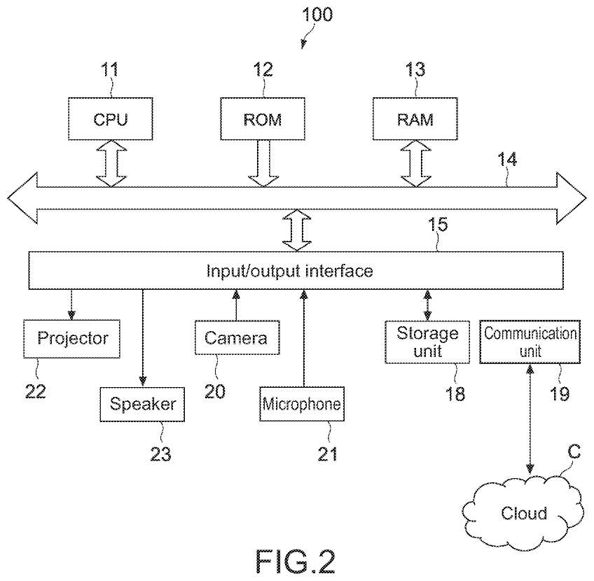

FIG. 1 is a diagram showing an AI speaker 100 according to the present embodiment (example of information processing apparatus) together with a situation of use thereof. FIG. 2 is a block diagram showing a hardware configuration of the AI speaker 100 according to the present embodiment.

The AI (Artificial Intelligence) speaker 100 is a hardware configuration in which a bus 14 connects a CPU 11, a ROM 12, an RAM 13, and an input/output interface 15. The input/output interface 15 is an input/output interface for information among a storage unit 18, a communication unit 19, a camera 20, a microphone 21, a projector 22, a speaker 23, and a main part of the AI speaker 100.

The CPU (Central Processing Unit) 11 is appropriately accesses to the RAM 13 or the like as necessary, and comprehensively controls all of each block while performing various arithmetic processing. The ROM (Read Only Memory) 12 is a non-volatile memory in which firmware such as a program or various parameters to be executed by the CPU 11 is fixedly stored. The RAM (Random Access Memory) 13 is used as a working area or the like of the CPU 11, and temporarily holds an OS (Operating System), various software being executed, and various data being processed.

The storage unit 18 is a non-volatile memory such as an HDD (Hard Disk Drive), a flash memory (SSD; Solid State Drive), and other solid-state memory. The storage unit 18 stores the OS (Operating System), various software, and various data. The communication unit 19 is a various module for wireless communication such as an NIC (Network Interface Card) and a wireless LAN, for example. The AI speaker 100 communicates information with a server group (not shown) on a cloud C through the communication unit 19.

The camera 20 includes, for example, a photoelectric conversion element, and images a situation around the AI speaker 100 as a captured image (including still image and moving image). The camera 20 may include a wide-angle lens.

The microphone 21 includes an element that converts a voice around the AI speaker 100 into an electrical signal. The microphone 21 of the present embodiment, in detail, includes a plurality of microphone elements, and respective microphone elements are installed at different positions of an exterior of the AI speaker 100.

The speaker 23 outputs notification information generated in the AI speaker 100 or the server group on the cloud C as the voice.

The projector 22 outputs the notification information generated in the AI speaker 100 or the server group on the cloud C as an image. FIG. 1 shows a situation in which the projector 22 outputs the notification information on a wall W.

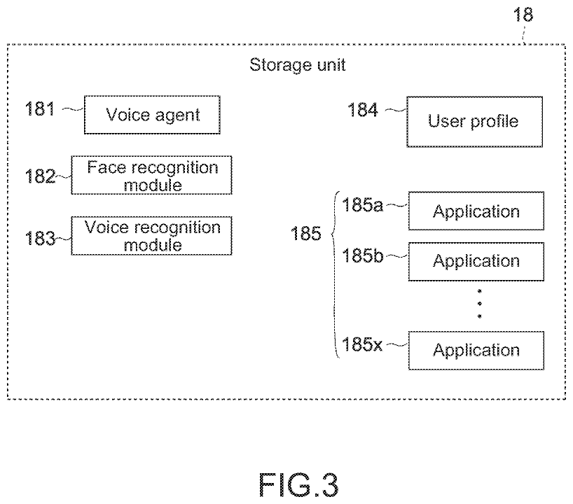

FIG. 3 is a block diagram showing content stored in the storage unit 18. The storage unit 18 stores a voice agent 181, a face recognition module 182, a voice recognition module 183, and a user profile 184 in a storage area, and also stores various applications 185 such as an application 185a and an application 185b.

The voice agent 181 is a software program that causes the CPU 11 to function as the control unit of the present embodiment by being called from the storage unit 18 by the CPU 11 and expanded on the RAM 13. The face recognition module 182 and the voice recognition module 183 are also software programs that add a face recognition function and a voice recognition function to the CPU 11 functioning as the control unit by being called from the storage unit 18 by the CPU 11 and expanded on the RAM 13.

In the following, unless otherwise noted, the voice agent 181, the face recognition module 182, and the voice recognition module 183 are handled as functional blocks, each of which is placed in a state in which the functions can be performed using hardware resources.

The voice agent 181 performs various processing on the basis of the voice of one or plurality of users input from the microphone 21. The various processing referred to herein include, for example, calling the appropriate application 185 and searching for a word extracted from the voice as a keyword.

The face recognition module 182 extracts a feature amount from input image information, and recognizes a human face on the basis of the extracted feature amount. The face recognition module 182 recognizes attributes of the recognized face (estimated age, skin color brightness, sex, and family relationship with registered user, etc.) on the basis of the feature amount.

A specific method of face recognition is not limited, but there is a method of, for example, extracting positions of facial parts such as eyebrows, eyes, a nose, a mouth, jaw contours, ears, and the like as a feature amount by image processing, and measuring similarity between the extracted feature amount and sample data. The AI speaker 100 accepts registration of a user name and a face image at the time of initial use by the user or the like. In the subsequent use, the AI speaker 100 estimates a family relationship between a person of the face image in the input image and the person of the registered face image by comparing the feature amounts of the registered face image and the face image recognized from the input image.

The voice recognition module 183 extracts a phoneme of a natural language from input voices from the microphone 21, converts the extracted phoneme into a word by dictionary data, and analyzes syntax. In addition, the voice recognition module 183 also identifies the user on the basis of a voiceprint or footsteps included in the input voice from the microphone 21. The AI speaker 100 receives the user's voiceprint or footsteps registration at the time of the initial use by the user or the like, and the voice recognition module 183 recognizes a person who is making the voice or the footsteps during the input voice by comparing the feature amounts of the registered voice print or footsteps and the input voice.

The user profile 184 is data that holds a name, a face image, an age, a gender, and other attributes of the user of the AI speaker 100 for each one or plurality of users. The user profile 184 is created manually by the user.

The applications 185 are a variety of software programs whose functions are not particularly limited. The applications 185 include, for example, an application that transmits and receives a message such as an e-mail, and an application that queries the cloud C to notify the user of weather information.

(Voice Input)

The voice agent 181 according to the present embodiment performs acoustic signal processing called beamforming. For example, the voice agent 181 enhances a sound collection directivity of the voice in one direction by lowering sensitivity of the voice in the other direction while assuring sensitivity of the voice in the one direction from voice information of the voice collected by the microphone 21. Furthermore, the voice agent 181 according to the present embodiment sets a plurality of directions for enhancing the sound collection directivity of the voice.

A state in which the sound collection directivity in a predetermined direction is enhanced by the acoustic signal processing can also be recognized as a state in which a virtual beam is formed from a sound collection device.

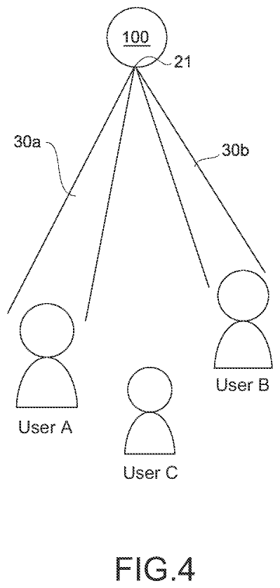

FIG. 4 is a diagram schematically showing a state in which the virtual beam for voice recognition is formed from the AI speaker 100 according to the present embodiment toward the user. In FIG. 4, the AI speaker 100 forms a beam 30a and a beam 30b from the microphone 21 toward a user A and a user B as speakers, respectively. Furthermore, the AI speaker 100 according to the present embodiment, as shown in FIG. 4, it can be beamformed to a plurality of users at the same time.

As shown in FIG. 4, when a state in which the beam 30a is regarded as being virtually formed from the microphone 21 of the AI speaker 100 toward the user A, the voice agent 181 enhances the sound collection directivity with respect to the voice in the direction of the beam 30a as described above. Thus, the possibility that the voice of another person other than the user A (e.g., user B or user C) or a surrounding sound of a television is less likely to be recognized as the voice of the user A.

The AI speaker 100 enhances the sound collection directivity of a predetermined user's voice, maintains the state, and, if a predetermined condition is satisfied, cancels the state (stops processing for enhancing sound collection directivity). While the sound collection directivity is enhanced, it is referred to as a “session” between the predetermined user and voice agent 181.

In the AI speaker in the related art, the user had to say a startup keyword each time to start the session. In contrast, the AI speaker 100 according to the present embodiment performs a control (to be described later) to select a target of the beamforming and acts on the user, so that the user can operate the AI speaker 100 with a simple operation. The following describes the control to select the target of beamforming of the AI speaker 100.

(Control to Select Target of Beamforming)

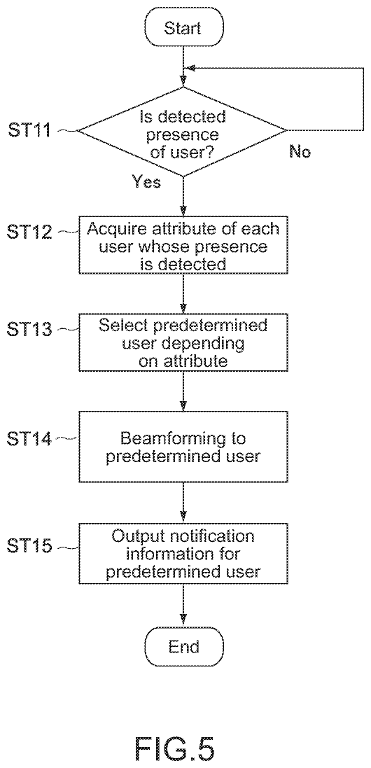

FIG. 5 is a flowchart showing a procedure of processing by the voice agent 181. In FIG. 5, the voice agent 181 first detects that there is one or more users around the AI speaker 100 (Step ST11).

The AI speaker 100, in the above Step ST11, detects the user on the basis of sensor information of the sensor such as the camera 20 and the microphone 21. Although the detection method of the user is not limited, for example, there are a method of extracting a person in an image by an image analysis, a method of extracting a voice print in a voice, a method of detecting footsteps, and the like.

Subsequently, the voice agent 181 acquires the attributes of the user whose presence is detected in Step ST11 (Step ST12). If a plurality of users is detected in Step ST11, the voice agent 181 may acquire respective attributes of the plurality of detected users. The attributes described herein are information same as the user name, the face image, the age, the gender, and other information held in the user profile 184. The voice agent 181 acquires the user name, the face image, the age, the gender, and other information as much as possible or as much as necessary.

A method of acquiring the attributes in Step ST12 will be described. In the present embodiment, the voice agent 181 calls the face recognition module 182, inputs the captured image of the camera 20 to the face recognition module 182, performs face recognition processing, and uses processed results. The face recognition module 182 outputs the attributes of the face recognized as described above (estimated age, brightness of skin color, gender, and family relationship with registered users) and the feature amount of the face image as the processed results.

The voice agent 181 acquires the attributes of the user (user name, face image, age, gender, and other information) on the basis of the feature amount of the face image and the like. The voice agent 181 further retrieves the user profile 184 and acquires the user name, the face image, the age, the gender, and other information held by the user profile 184 as the attributes of the user on the basis of the feature amount of the face image and the like.

Note that the voice agent 181 may use the face recognition processing performed by the face recognition module 182 to detect the presence of the plurality of users in Step ST11.

Note that the voice agent 181 may identify an individual depending on the voice print of the user included in the voice of the microphone 21 and acquire the attributes of the identified individuals from the user profile 184.

Subsequently, the voice agent 181 selects at least one or more user(s) depending on the attributes of the user acquired in Step ST12 (Step ST13). In the following Step ST14, the beams of the voice input described above are formed toward a direction of the user selected in Step ST13.

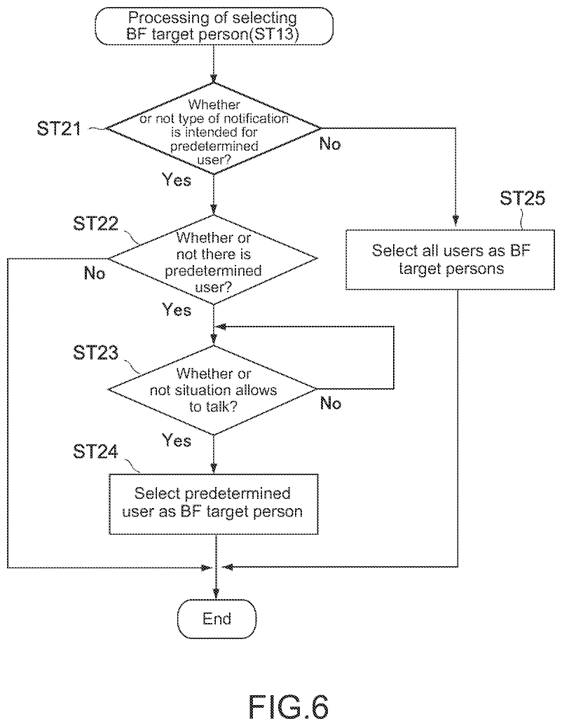

A method of selecting the user depending on the attributes in Step ST13 will be described with reference to FIG. 6. FIG. 6 is a flowchart showing a method of selecting the user depending on the attributes in the present embodiment.

The voice agent 181 first detects presence or absence of the notification information generated by the applications 185, and determines whether or not the notification information is intended for all or a predetermined user (Step ST21). The voice agent 181 may determine in Step ST21 depending on types of the applications 185 that generate the notification information.

For example, if the type of application 185 is an application that notifies weather information, the voice agent 181 determines that it is not intended for the predetermined user (Step ST21: No). On the other hand, if the type of the application 185 is an application that purchases an article and/or a service (hereinafter, “application for purchase”), the voice agent 181 determines that the application is intended for the predetermined user (Step ST21: Yes).

If the notification information is directed to an individual, the voice agent 181 determines that the “predetermined user” is the individual. Furthermore, if the notification information is notification information of the application for purchase, the voice agent 181 sets a user of a predetermined age or a predetermined age group or more as the “predetermined user”.

If the notification information is for the predetermined user (Step ST21: Yes), the voice agent 181 determines whether or not there is the predetermined user among the plurality of users specified by the face recognition (Step ST22), and if not, suspends the processing (Step ST22: No).

If there is the predetermined user (Step ST22: Yes), the voice agent 181 determines whether or not the situation allows to talk to the predetermined user (Step ST23). For example, if there is the situation in which the users talk, the voice agent 181 determines that the situation does not allow to talk (Step ST23: No).

If it is determined that the situation allows to talk to the predetermined user (Step ST23: YES), the voice agent 181 selects the predetermined user as a beamforming target person (Step ST24). The user selected in Step ST24 is referred to as the “selected user” for convenience in the following.

Note that if it is determined in Step ST22 that is not intended for the predetermined user (Step ST21: No), the voice agent 181 selects all of the plurality of users identified by the face recognition as the “selected users”, that is, the beamforming target persons (Step ST25).

The method of selecting the user depending on the attributes in Step ST13 is described above. Note that, in the above method, the voice agent 181 selects the selected user(s) depending on the types of the applications. Alternatively, the voice agent 181 may determine, on the basis of information of a target age included in the notification information of the application 185, whether or not the notification information is intended for the user of the predetermined age or more, and, if the notification information is intended for the user of the predetermined age or more, may exclude the users who are determined not to reach the predetermined age from the selected users.

Note that in the determination of Step ST23, the voice agent 181 may determine whether or not it allows to talk or does not allow to talk depending on an urgency of the notification information. In the case of an emergency call, the voice agent 181 may set the above-mentioned beamforming for the predetermined user or all users regardless of the situation, and may start the session.

In FIG. 5, the voice agent 181 performs beamforming on the user selected in Step ST13 (Step ST14). This starts the session between the selected user and voice agent 181.

Next, the voice agent 181 outputs the notification information for the user to the projector 22, the speaker 23, and the like (Step ST15).

As described above, since the AI speaker 100 according to the present embodiment selects the target of beamforming, at the time of switching from a not-in-use state to an in-use state, the sound collection directivity of the voice of the user is enhanced without waiting for the user to utter an activation keyword or the like. As a result, the user's operation becomes simpler.

Furthermore, in the present embodiment, since the user is selected depending on the types of the applications that generate the notification information and the attributes of the user, the voice agent 181 can actively select the user to be enhanced of the sound collection directivity.

Furthermore, in the present embodiment, when the application for purchasing the article or the like notifies the user of something, the user to be enhanced of the sound collection directivity is limited to the user having the predetermined age or more, which allows to provide the information processing apparatus that can be used at ease.

Furthermore, in the present embodiment, since the voice agent 181 detects the plurality of users from the captured image by the face recognition processing, and selects the user depending on the attributes of the user detected by the face recognition processing, it is possible to select the user to be beamformed with high accuracy.

(Maintain of Beamforming)

The voice agent 181 maintains the session with the user while the predetermined condition is satisfied. For example, the voice agent 181 moves and follows the beam 30 of beamforming in a direction in which the user moves on the basis of the captured image of the camera 20. Alternatively, if the user moves more than a predetermined amount, the voice agent 181 may suspend the session once, set an area of beamforming in the moving direction, and resume the session. Resetting of beamforming can reduce the information processing as compared with the following of the beam 30. A specific mode of maintaining the session may be any of the following of the beam 30 or the resetting of the beamforming, or the two may be combined.

In addition, the voice agent 181 recognizes an orientation of the face on the basis of the face recognition of the captured image of the camera 20, and determines the end of the session if the user does not see a screen displayed by the projector 22. The voice agent 181 may monitor a motion of a mouth in the captured image.

According to the present embodiment, by using the captured image and the voice information together, it is possible to narrowly limit the area of the beamforming and to improve a voice recognition accuracy. In addition, it is possible to follow the movement or a change in posture of the person.

(Stop Beamforming)

The voice agent 181 stops the beamforming if it determines the end of the session. This prevents erroneous operations and malfunctions. More specifically, conditions for determination of the end of the session will be described below.

The voice agent 181 forms a beam (beamforming) with respect to the direction of the user selected in Step ST13, and stops the beamforming when the utterance from the user is not detected through the microphone 21 for a predetermined period of time.

However, in the present embodiment, the voice agent 181 sets a length of the predetermined time for which the utterance is not detected depending on the attributes acquired for the user in Step ST12. For example, a longer time is set for the users having the attributes of the predetermined age or age group or more. Also, a longer time than normal is set for the users having the attributes of the predetermined age or age group or less. Thus, a longer time is set for each user who is expected to be unfamiliar with the operation of the AI speaker 100, such as an elderly person or a child, and the user's operation becomes simpler.

Furthermore, the voice agent 181 according to the present embodiment stops the beamforming and suspends the session if the utterance from the user is not detected for the predetermined time, and also stops the beamforming and suspends the session depending on the attributes of the user if the predetermined notification information is input from the application 185. The application 185 may generate any notification information after establishing the session between the user and the voice agent 181, and before suspending the session (stopping beamforming). In such a case, the voice agent 181 suspends the session (stops beamforming) depending on the attributes of the user.

Specifically, for example, if the notification information of the application for purchase is generated, the voice agent 181 determines whether or not the age of the user is the predetermined age or less on the basis of the attributes, and if the age is the predetermined age or less, the beamforming is suspended.

The voice agent 181 may further use conditions for stopping the beamforming that there is no utterance of the user for a predetermined period of time after an agent response, that a situation in which the user's face is not recognized from the captured image of the camera 20 continues for a predetermined period of time, that a normal state in which the user does not see a drawing area of the projector 22 continues for a predetermined period of time or longer, and the like.

Furthermore, in this case, the voice agent 181 may set each predetermined time depending on the types of the applications 185. Alternatively, the predetermined time may be lengthened if an amount of information displayed on the screen is large, or the predetermined time may be shortened if the amount of information is small or if the type of application is frequently used. The amount of information herein includes the number of characters, the number of words, the number of content such as still images and moving images, a play time of the content, and things of the contents. For example, the voice agent 181 increases the predetermined time when displaying excursion information including a large amount of character information, and decreases the predetermined time when displaying weather information having a small amount of character information.

Alternatively, in this case, the voice agent 181 may extend each predetermined time when it takes time for the user to make a decision about the notification information or to input the notification information.

(Feedback)

The voice agent 181 returns feedback to indicate to the user that the session is maintained while the beamforming and the session are maintained. The feedback includes the image information drawn by the projector 22 and the voice information output from the speaker 23.

In the present embodiment, in a case where the session is maintained and there is no user input, the voice agent 181 changes the content of the image information depending on the length of time in which there is no user input. For example, when the state in which the session is maintained is indicated by drawing a circle, the voice agent 181 reduces the size of the circle depending on the length of time in which there is no user input. By configuring the AI speaker 100 in this manner, the user can visually recognize a maintaining time of the session, thereby further improving an ease of use of the AI speaker 100.

In this case, if a frequency of stopping the session due to the timeout is a predetermined frequency or more and the number of times the user utters the activation keyword every time and restarts the session is the predetermined number of times or more, the voice agent 181 lengthens the time until the timeout. By configuring the AI speaker 100 in this manner, it is possible to establish the session with a more appropriate length, thereby further improving the ease of use of the AI speaker 100.

If a large amount of noise is acquired on the basis of an S/N ratio and it is determined that the noise is large, the voice agent 181 may increase the time to the timeout. Also, if it is detected that a distance to the user uttered is too long, the time to the timeout may also be lengthened. In addition, if it is also detected that the voice is acquired from an angle close to a limit of a range that can be acquired by the microphone 21, the time until the timeout may also be lengthened. By configuring the AI speaker 100 in this manner, the ease of use of the AI speaker 100 is further improved.

The above-described voice agent 181 may lengthen the time until the above-described timeout depending on the attributes of a speaker that are acquired on the basis of the feature amount of the face image or a voice quality, such as a speaker who utters the startup keyword, the last speaker among the plurality of speakers, an adult speaker, a child speaker, a male speaker, and a female speaker or on an utterance timing. By configuring the AI speaker 100 in this manner, the ease of use of the AI speaker 100 is further improved. In particular, even if the user does not register the face image or the voiceprint, the time until the timeout is extended depending on the attributes determined on the basis of the feature amount or the voice quality of the face image, so that there is no need to identify individuals and the ease of use of the AI speaker 100 is further improved.

The voice agent 181 may set the time until the timeout depending on a start mode of the session. For example, if the session is started by uttering the user the startup keyword, calling the voice agent 181, the voice agent 181 relatively lengthens the time until the timeout. In addition, in a case where the voice agent 181 automatically sets the beamforming to the direction of the user and starts the session, the voice agent 181 relatively shortens the time until the timeout.

The above-described embodiments can be modified and embodied in a variety of modes. Hereinafter, modified examples of the above-described embodiment will be described.

### Second Embodiment

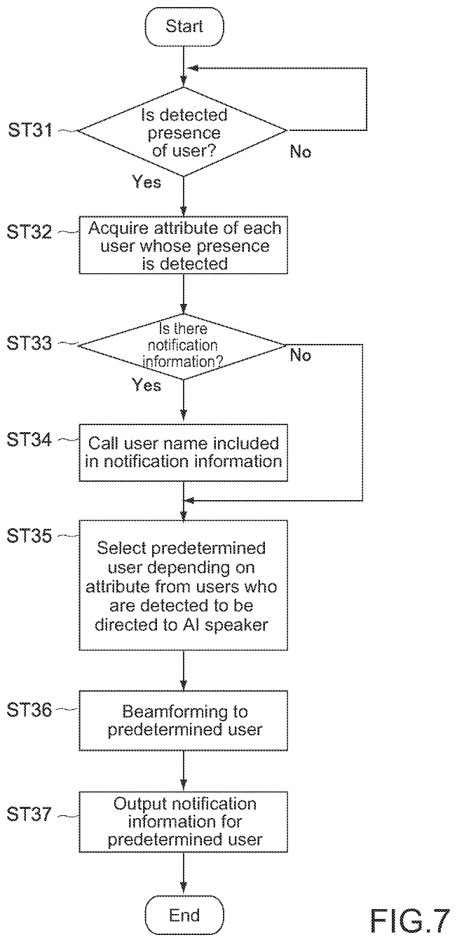

Hardware configuration and software configuration of the present embodiment are the same as those of the first embodiment and can be implemented. The control to select the target of beamforming in the present embodiment will be described with reference to FIG. 7.

FIG. 7 is a flowchart of the control to select the target of beamforming of the present embodiment. Steps ST31 and ST32 of FIG. 7 are the same as Steps ST11 and 12 of FIG. 5. In addition, Steps ST36 and 37 in FIG. 7 are the same as Steps ST14 and 15 in FIG. 5.

On the other hand, in the present embodiment, the voice agent 181 confirms whether or not there is the notification information to the user (which may be one person) after the attributes of the user are acquired (Step ST33).

If there is no notification information (Step ST33: No), the voice agent 181 performs processing in the same manner as in the first embodiment (Step ST35).

If there is the notification information (Step ST33: YES), the voice agent 181 outputs attention drawing information to the user via the projector 22 and the speaker 23 (Step ST34). The attention drawing information may be anything that causes a user's attention to be directed to the AI speaker 100, but in the present embodiment, the attention drawing information includes a user name (Step ST34).

Specifically, the voice agent 181 acquires the user name included in the notification information whose presence is detected in Step ST33, and generates the attention drawing information including the acquired user name. The voice agent 181 then outputs the generated attention drawing information. A mode of the output is not limited, but in the present embodiment, the user name is called from the speaker 23. For example, a voice such as “A, you got an e-mail” is reproduced from the speaker 23.

The voice agent 181 then selects the user to be beamformed depending on the attributes from among the users who are detected to be directed to the AI speaker 100 by the face recognition using the face recognition module 182 (Step ST35). That is, the voice agent 181 selects the user to be beamformed from among the users who are called and turned around by the name. However, the voice agent 181 may set the beamforming to the user at a timing after Step ST34 and before Step ST35 in a case where the user whose name is called is a registered user whose face image is registered and the face image is present in the captured image and is directed toward the AI speaker 100.

In the present embodiment, if the voice agent 181 has at least one piece of the notification information, the voice agent 181 outputs the attention drawing information and selects the user from among the users who are detected to be directed to the AI speaker 100, so that the user's sound collection directivity in response to the attention drawing information is improved. Therefore, the user's operation becomes simpler.

Furthermore, in the present embodiment, since the voice agent 181 outputs the attention drawing information including the user name included in the notification information, it is possible to improve a response of the user who is called the name.

### Third Embodiment

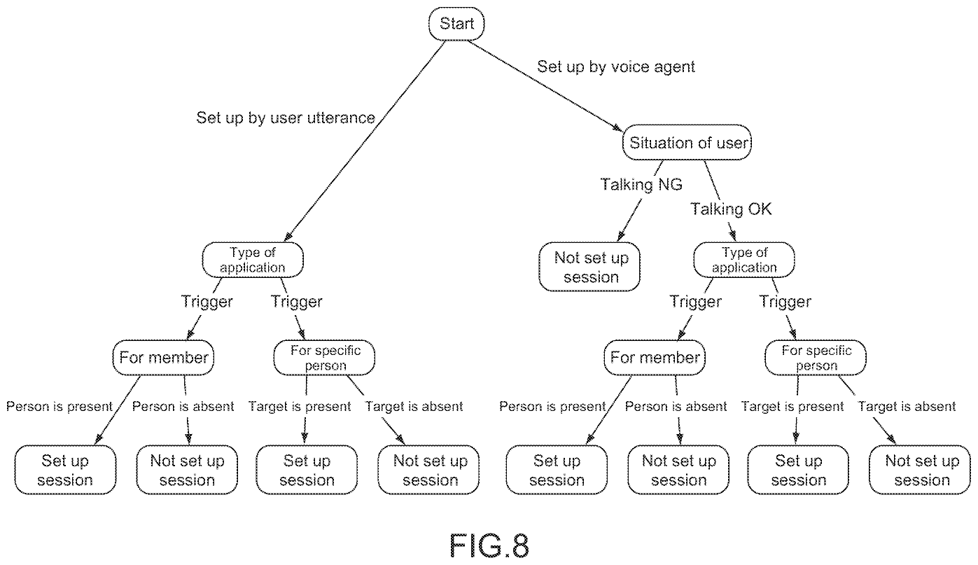

A modification example of the first and second embodiments will be described below as a third embodiment. As hardware configuration and software configuration of the AI speaker 100 according to the present embodiment, those of similar to the above-described embodiment can be used. FIG. 8 is a block diagram showing a flow of each procedure of information processing according to the present embodiment.

In the present embodiment, after the presence of the user is detected, it is determined whether or not the session is established between the voice agent 181 and the user in accordance with the process shown in FIG. 8. In FIG. 8, “establishing the session” is expressed as “set up the session”.

In FIG. 8, after the presence of the user is detected by the sensor information of the sensor, the voice agent 181 first determines whether or not an utterance of the startup keyword by the user is present. If there is a user utterance, the voice agent 181 determines presence or absence of a trigger depending on presence or absence of the notification information of other application. If there is the notification information, the voice agent 181 determines that there is the trigger.

If it is determined that there is the trigger, the voice agent 181 selects a logic to determine whether or not to establish the session, depending on the application having the notification information. In the present embodiment, the voice agent 181 determines session establishment logics in at least two cases, i.e., in a case where a notification target of the notification information is for a member as well as in a case where the notification target of the notification information is for a specific person.

The voice agent 181 determines the case of the session establishment logic depending on the types of applications. The notification information for the member includes, for example, notification information of a social network service. The notification information for the specific person includes, for example, notification information of the application for purchase capable of purchasing articles or services.

Note that, in other case, for example, a case where there are unspecified large number of the notification targets may be determined depending on the types of the applications. Incidentally, in a case where there are unspecified large number of the notification targets, the voice agent 181 establishes the session without determining anything in particular.

In a case where it is determined that the notification target is for the member depending on the types of the applications, the voice agent 181 determines whether or not the member to be notified is in the vicinity of the AI speaker 100 on the basis of the sensor information of the sensor such as the camera 20. For example, in a case where presence of the face of the member is recognized in the camera image captured by the camera 20, the voice agent 181 determines that the member is present.

In a case where it is determined that the member is present, the voice agent 181 sets the beamforming so that the beam 30 is formed in the area where is determined that the member is present on the basis of the sensor information, and establishes the session. In a case where it is determined that the member is absent, the voice agent 181 does not establish the session.

In a case where it is determined that the notification target is for the specific person depending on the types of applications, the voice agent 181 determines whether or not a person corresponding to the specific person is in the vicinity of the AI speaker 100 on the basis of the sensor information of the sensor such as the camera 20. For example, in the case of the above-mentioned application for purchase, the voice agent 181 determines whether or not there is an adult on the basis of the face image. In a case where the adult is present, the voice agent 181 sets the beamforming so that the beam 30 is formed for the adult, and establishes the session. In a case where it is determined that the adult is absent, the voice agent 181 does not establish the session.

Note that the voice agent 181 may determine whether or not the specific person (e.g., adult) is present as the notification target on the basis of the face recognition of the image of the camera 20, may determine on the basis of voice print recognition of voice of the microphone 21, or may determine on the basis of individual identification by footsteps.

On the other hand, after the voice agent 181 detects the presence of the user by the sensor information of the sensor, if there is no utterance of the startup keyword, the voice agent 181 determines whether or not to establish the session from a voice agent 181 side by the process described below.

In this case, the voice agent 181 determines whether or not the situation of the user is the situation allows to talk to the user on the basis of the sensor information of the sensor. For example, if the camera 20 is used as the sensor, the voice agent 181 determines that the situation does not allow to talk to the user if it detects that the users are facing each other to talk to with each other or face in a direction other than the direction of the AI speaker 100.

In a case where the session is established from the voice agent 181 side and it is determined that the situation is the situation allows to talk to the user, the voice agent 181 selects the session establishment logic depending on the types of applications by triggering that the application includes the notification information, and determines whether or not to establish the session. These steps are the same as a session establishment method based on the detection of the user utterance described above.

According to the embodiment described above, if there is the notification information even without the user utterance, the voice agent 181 automatically sets the beamforming so that the beam 30 is formed for the user and the session is established between the user and the voice agent 181, thereby further improving the ease of the user's operation. Furthermore, even if there is the user utterance, since the beamforming is set and the session is established in the same manner, the user's operation can be made simpler.

### Other Embodiments

While preferable embodiments of the present technology have been described above by way of example, the embodiments of the present technology are not limited to those described above.

### MODIFIED EXAMPLE 1

For example, in the second embodiment, the attention drawing information is output only when there is the notification information, but in other embodiments, the attention drawing information may be output regardless of presence or absence of the notification information. In this case, for example, if the presence of the plurality of users is detected, the voice agent 181 may output a voice such as “Good morning!” as the attention drawing information. Since a possibility of the users to direct to the AI speaker 100 increases, there is an effect that an accuracy of the face recognition using the camera 20 is improved.

### MODIFIED EXAMPLE 2

In the first, second, and third embodiments, the presence of the user is recognized on the basis of an input from a sensing device such as the camera 20, and the session is started by setting the beamforming in the direction of the user, but the present technology is not limited to thereto. The AI speaker 100 may set the beamforming and start the session by uttering the startup keyword by the user to the AI speaker 100 (or voice agent 181).

Furthermore, in this case, the AI speaker 100 may set the beamforming so that when one of the plurality of users utters the startup keyword, the beam 30 also hits the user(s) around the user uttered, and start the session. At this time, the AI speaker 100 may set the beamforming to the user facing the direction of the AI speaker 100 or the user facing the direction of the AI speaker 100 immediately after the startup keyword is uttered, and may start the session.

According to the modified example, the session can be started not only for the user who utters the startup keyword but also for the user who does not utter the startup keyword, and the ease of use of the AI speaker 100 can be improved for the user who does not utter the startup keyword.

However, in the modified example, the AI speaker 100 may not automatically set the beamforming to the user who does not satisfy a predetermined condition (and may not start session).

The predetermined condition may be applicable, for example, to a user who registers the face image, the voiceprint, the footsteps, or other information for specifying the individual in the AI speaker 100, or may be a family member of the registered user. That is, if the user does not correspond to the registered user or the family thereof, the session is not automatically started. By configuring the AI speaker 100 in this manner, security is improved, and an unintended operation can be suppressed.

As other example of the predetermined condition, there is a condition that the age reaches adulthood. In this case, the AI speaker 100 does not set the beamforming (and does not start session) in a minor age if it includes the notification information generated by the application 185 capable of purchasing the articles or the services. By configuring the AI speaker 100 in this manner, the user can use the AI speaker 100 at ease. Incidentally, whether or not the user is a minor is determined on the basis of the registration information of the user or the like.

In the modified example, the AI speaker 100 not only sets the beamforming to the user whose face is visible immediately after voice acquisition of the startup keyword and starts the session, but also may output a notification sound from the speaker 23. With this configuration, the user can direct the face toward the AI speaker 100. The AI speaker 100 may also set the beamforming and start the session for those who direct the face. In this manner, by setting the beamforming with a margin of several seconds and starting the session, the ease of use is further improved.

In the modified example, the beamforming may be set and the session may be started for the user who gazes at the screen for several seconds immediately after the voice acquisition of the startup keyword.

### MODIFIED EXAMPLE 3

In the above-described embodiment described above, the AI speaker 100 including the control unit configured by the CPU 11 or the like and the speaker 23 is disclosed, but the present technology can be implemented by other apparatuses, and may be implemented by an apparatus including no speaker 23. In this case, the apparatus may have an output unit for separately outputting the voice information from the control unit to an external speaker.

(Appendix)

The present technology may have the following structures.
(1)

An information processing apparatus, comprising:

a control unit that
detects a plurality of users from sensor information from a sensor,
selects at least one user depending on attributes of the plurality of users,
controls so as to enhance a sound collection directivity of a voice of the user among voices input from a microphone, and
controls so as to output notification information for the user.
(2)

The information processing apparatus according to (1), in which

the control unit
confirms presence or absence of the notification information for at least any of the plurality of users,
in a case where at least one piece of notification information is present, controls so as to output attention drawing information for drawing an attention to the information processing apparatus, and
selects the user from among users who are detected to be directed to a direction of the information processing apparatus with respect to the attention drawing information.
(3)

The information processing apparatus according to (2), in which

the control unit
acquires a user name included in the notification information for at least any of the plurality of users,
generates the attention drawing information including the acquired user name, and
controls so as to output the attention drawing information.
(4)

The information processing apparatus according to any of (1) to (3), in which

the notification information is generated by any of a plurality of applications, and

the control unit selects the user depending on the attributes and types of the applications that generate the notification information.
(5)

The information processing apparatus according to (4), in which

the attributes include an age,

the types of the plurality of applications include at least applications each having a function of purchasing at least one of an article or a service, and

the control unit selects the user from among users having ages of a predetermined age or more in a case where the types of the applications that generate the notification information correspond to the applications each having the function of purchasing at least one of the article or the service.
(6)

The information processing apparatus according to any of (1) to (5), in which

the control unit
detects the plurality of users from the captured image by face recognition processing, and
selects the user depending on the attributes of the users detected by the face recognition processing.
(7)

The information processing apparatus according to any of (1) to (6), in which

the attributes includes an age, and

the control unit
confirms presence or absence of the notification information to at least any of the plurality of users, and
selects the user from among the users who have predetermined ages or more among the plurality of users detected from the captured image in a case where the notification information is present and the notification information is intended for the users having the predetermined ages or more.
(8) The information processing apparatus according to any of (1) to (7), in which

the control unit
in a case where an utterance from the user is not detected for a predetermined period of time after the control to enhance the sound collection directivity of the voice of the user is performed, stops the control, and
sets a length of the predetermined period of time depending on the attributes acquired for the user.
(9) The information processing apparatus according to any of (1) to (8), in which

the control unit
in a case where the notification information relating to a purchase of at least one of the article or the service is generated, suspends the control to enhance the sound collection directivity depending on the attributes of the user.
(10) A control method of an information processing apparatus, including:

detecting a plurality of users from sensor information from a sensor;

selecting at least one user depending on attributes of the plurality of users;

controlling so as to enhance a sound collection directivity of a voice of the user among voices input from a microphone; and

controlling so as to output notification information for the user.
(11) A program executable by an information processing apparatus, the program causing the information processing apparatus to execute:

a step of detecting a plurality of users from sensor information from a sensor;

a step of selecting at least one user depending on attributes of the plurality of users;

a step of controlling so as to enhance a sound collection directivity of a voice of the user among voices input from a microphone; and

a step of controlling so as to output notification information for the user.

### REFERENCE SIGNS LIST

100 AI speaker
20 camera
21 microphone
22 projector
23 speaker
181 voice agent
182 face recognition module
183 voice recognition module
184 user profile
185 application

1. An information processing apparatus, comprising:
a control unit that
detects a plurality of users from sensor information,
selects at least one user depending on attributes of the plurality of users,
controls so as to enhance a sound collection directivity of a voice of the user among input voices, and
controls so as to output notification information for the user.

2. The information processing apparatus according to claim 1, wherein
the control unit
confirms presence or absence of the notification information for at least any of the plurality of users,
in a case where at least one piece of notification information is present, controls so as to output attention drawing information for drawing an attention to the information processing apparatus, and
selects the user from among users who are detected to be directed to a direction of the information processing apparatus with respect to the attention drawing information.

3. The information processing apparatus according to claim 2, wherein
the control unit
acquires a user name included in the notification information for at least any of the plurality of users,
generates the attention drawing information including the acquired user name, and
controls so as to output the attention drawing information.

4. The information processing apparatus according to claim 1, wherein
the notification information is generated by any of a plurality of applications, and
the control unit selects the user depending on the attributes and types of the applications that generate the notification information.

5. The information processing apparatus according to claim 4, wherein
the attributes include an age,
the types of the plurality of applications include at least applications each having a function of purchasing at least one of an article or a service, and
the control unit selects the user from among users having ages of a predetermined age or more in a case where the types of the applications that generate the notification information correspond to the applications each having the function of purchasing at least one of the article or the service.

6. The information processing apparatus according to claim 1, wherein
the control unit
detects the plurality of users from the captured image by face recognition processing, and
selects the user depending on the attributes of the users detected by the face recognition processing.

7. The information processing apparatus according to claim 1, wherein
the attributes includes an age, and
the control unit
confirms presence or absence of the notification information to at least any of the plurality of users, and
selects the user from among the users who have predetermined ages or more among the plurality of users detected from the captured image in a case where the notification information is present and the notification information is intended for the users having the predetermined ages or more.

8. The information processing apparatus according to claim 1, wherein
the control unit
in a case where an utterance from the user is not detected for a predetermined period of time after the control to enhance the sound collection directivity of the voice of the user is performed, stops the control, and
sets a length of the predetermined period of time depending on the attributes acquired for the user.

9. The information processing apparatus according to claim 1, wherein
the control unit
in a case where the notification information relating to a purchase of at least one of the article or the service is generated, suspends the control to enhance the sound collection directivity depending on the attributes of the user.

10. A control method of an information processing apparatus, comprising:
detecting a plurality of users from sensor information;
selecting at least one user depending on attributes of the plurality of users;
controlling so as to enhance a sound collection directivity of a voice of the user among input voices; and
controlling so as to output notification information for the user.

11. A program executable by an information processing apparatus, the program causing the information processing apparatus to execute:
a step of detecting a plurality of users from sensor information;
a step of selecting at least one user depending on attributes of the plurality of users;
a step of controlling so as to enhance a sound collection directivity of a voice of the user among input voices; and
a step of controlling so as to output notification information for the user.
